(19) United States
(12) Patent Application Publication
(10) Pub. No.: US 2011/0238946 A1
(43) Pub. Date: Sep. 29, 2011

(54) Data Reorganization through Hardware-Supported Intermediate Addresses

(75) Inventors: Ramakrishnan Rajamony, Austin, TX (US); William E. Speight, Austin, TX (US); Lixin Zhang, Austin, TX (US)

(73) Assignee: INTERNATIONAL BUSINESS MACHINES CORPORATION, Armonk, NY (US)

(21) Appl. No.: 12/730,285

(22) Filed: Mar. 24, 2010

(51) Int. Cl. G06F 12/10

(52) U.S. Cl. 711/203; 711/E12.068

(57) ABSTRACT

A virtual address scheme for improving performance and efficiency of memory accesses of sparsely-stored data items in a cached memory system is disclosed. In a preferred embodiment of the present invention, a special address translation unit is used to translate sets of non-contiguous addresses in real memory into contiguous blocks of addresses in an “intermediate address space.” This intermediate address space is a fictitious or “virtual” address space, but is distinguishable from the virtual address space visible to application programs, and in user-level memory operations, effective addresses seen/manipulated by application programs are translated into intermediate addresses by an additional address translation unit for memory caching purposes. This scheme allows non-contiguous data items in memory to be assembled into contiguous cache lines for more efficient caching/access (due to the perceived spatial proximity of the data from the perspective of the processor).

### BACKGROUND OF THE INVENTION

1. Technical Field

The present invention relates generally to memory systems, and more specifically to a memory system providing greater efficiency and performance in accessing sparsely stored data items.

2. Description of the Related Art

Many modern computer systems rely on caching as a means of improving memory performance. A cache is a section of memory used to store data that is used more frequently than those in storage locations that may take longer to access. Processors typically use caches to reduce the average time required to access memory, as cache memory is typically constructed of a faster (but more expensive or bulky) variety of memory (such as static random access memory or SRAM) than is used for main memory (such as dynamic random access memory or DRAM). When a processor wishes to read or write a location in main memory, the processor first checks to see whether that memory location is present in the cache. If the processor finds that the memory location is present in the cache, a cache hit has occurred. Otherwise, a cache miss is present. As a result of a cache miss, a processor immediately reads the data from memory or writes the data to a cache line within the cache. A cache line is a location in the cache that has a tag containing an index of the data in main memory that is stored in the cache. Cache lines are also sometimes referred to as cache blocks.

Caches generally rely on two concepts known as spatial locality and temporal locality. These assume that the most recently used data will be re-used soon, and that data close in memory to currently accessed data will be accessed in the near future. In many instances, these assumptions are valid. For instance, single dimensional arrays that are traversed in order follow this principle, since a memory access to one element of the array will likely be followed by an access to the next element in the array (which will be in the next adjacent memory location). In other situations, these principles have less application. For instance, a column-major traversal of a two-dimensional array stored in row-major order will result in successive memory accesses to locations that are not adjacent to each other. In situations such as this, where sparsely-stored data must be accessed the performance benefits associated with caching may be significantly offset by the fact that many successive cache misses are likely to be triggered by the spaced memory accesses.

### SUMMARY OF THE INVENTION

The present invention provides a virtual address scheme for improving performance and efficiency of memory accesses of sparsely-stored data items in a cached memory system. In a preferred embodiment of the present invention, a special address translation unit is used to translate sets of non-contiguous addresses in real memory into contiguous blocks of addresses in an “intermediate address space.” This intermediate address space is a fictitious or “virtual” address space, but is distinguishable from the effective address space visible to application programs, and in user-level memory operations. Effective addresses seen and manipulated by application programs are translated into intermediate addresses by an additional address translation unit for memory caching purposes. This scheme allows non-contiguous data items in memory to be assembled into contiguous cache lines for more efficient caching/access (due to the perceived spatial proximity of the data from the perspective of the processor).

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of a data processing system in accordance with a preferred embodiment of the present invention;

FIG. 2 is a diagram illustrating intermediate address translation in accordance with a preferred embodiment of the present invention;

FIG. 3 is a diagram illustrating a situation in which access of sparsely-stored data triggers multiple successive cache misses; and

FIG. 4 is a diagram illustrating the use of an intermediate address space to improve cache performance and efficiency in accordance with a preferred embodiment of the present invention.

### DETAILED DESCRIPTION

The following is intended to provide a detailed description of an example of the invention and should not be taken to be limiting of the invention itself. Rather, any number of variations may fall within the scope of the invention, which is defined in the claims following the description.

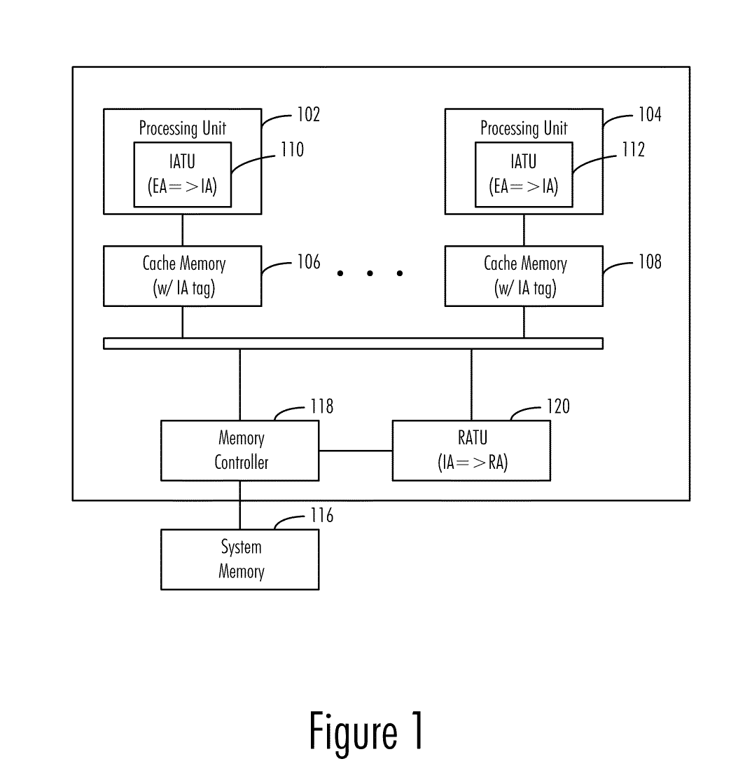

FIG. 1 is a block diagram of a data processing system 100 in accordance with a preferred embodiment of the present invention. Data processing system 100, here shown in a symmetric multiprocessor configuration (as will be recognized by the skilled artisan, other single-processor and multiprocessor arrangements are also possible), comprises a plurality of processing units 102 and 104, which provide the arithmetic, logic, and control-flow functionality to the machine and which share use of the main physical memory (116) of the machine through a common system bus 114. Processing units 102 and 104 may also contain one or more levels of on-board cache memory, as is common practice in present day computer systems. Associated with each of processing units 102 and 104 is a memory cache (caches 106 and 108, respectively). Although caches 106 and 108 are shown here as being external to processing units 102 and 104, it is not essential that this be the case, and caches 106 and 108 can also be implemented as internal to processing units 102 and 104. The skilled reader will also recognize that caches 106 and 108 may be implemented according to a wide variety of cache replacement policies and cache consistency protocols (e.g., write-through cache, write-back cache, etc.).

The skilled reader will understand in the present art, most memory caches are indexed according to the physical addresses in main memory to which each cache line in the cache corresponds (generally through the use of a plurality of “tag bits” which are a portion of that physical address denoting the location of the cache line in main memory). Caches 106 and 108 in this preferred embodiment, however, are indexed according a fictitious or “virtual” address space referred to herein as the “intermediate address space,” which will be described in more detail below. Each of processing units 102 and 104 is equipped with an “intermediate address translation unit” (IATU) (110 and 112, respectively), which translates effective addresses in the virtual memory space in which the processor operates into intermediate addresses in the intermediate address space. The skilled reader will recognize that this function is essentially identical to the function performed by conventional address translation units in virtual memory systems as existing in the art, with the exception that instead of translating virtual addresses into real (physical) addresses, IATUs 110 and 112 translate the user-level virtual addresses (here called “effective addresses”) into intermediate addresses.

A memory controller unit 118, positioned between system bus 114 and main memory 116, serves as an intermediary between caches 106 and 108 and main memory 116, managing the actual memory caching and preserving consistency of data between caches 106 and 108. In addition to memory controller unit 118, however, there is included a “real address translation unit” (RATU) 120, which is used to define a mapping between intermediate addresses (in the fictitious “intermediate address space”) and real addresses in physical memory (main memory 116). RATU 120, as its name indicates, translates intermediate addresses into real addresses for use in accessing main memory 116.

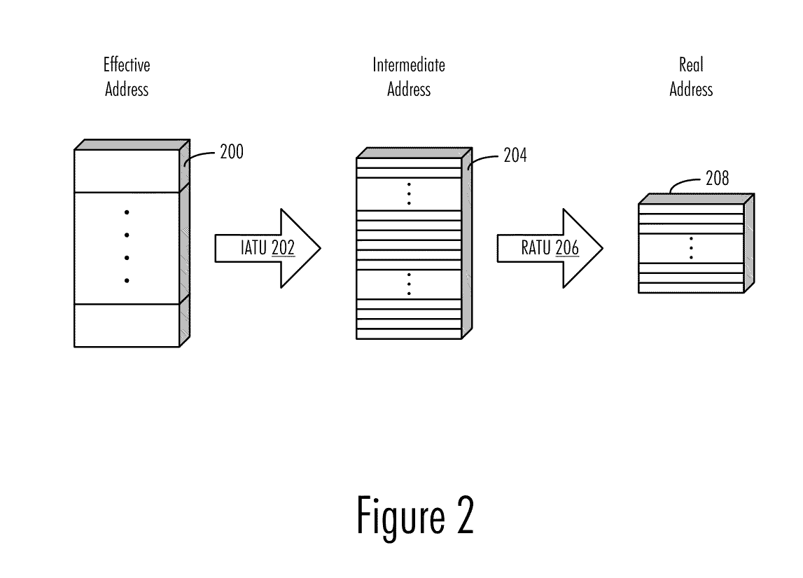

The conceptual operation of intermediate addresses in the context of a preferred embodiment of the present invention is shown in FIG. 2. Effective addresses (the addresses seen by each processing unit) in “effective address space” 200 are translated by IATU 202 into intermediate addresses (the addresses used for caching purposes) in “intermediate address space” 204. RATU 206 maps/translates these intermediate addresses into real addresses in “real address space” 208 (i.e., the physical memory addresses of main memory).

With regard to the address mapping provided by RATU 206, it is important to note the manner in which the addresses are mapped in order to appreciate many of the advantages provided by a preferred embodiment of the invention. Firstly, in a preferred embodiment, the mapping between intermediate addresses and real addresses is bijective. That is, the mapping is “one-to-one” and “onto.” Each address in real address space 208 corresponds to one and only one address in intermediate address space 204.

Secondly, the mapping is fine-grained. In other words, the mapping is from individual memory address to individual memory address. This fine-grained mapping permits individual non-contiguous memory locations in real address space 208 to be mapped into contiguous memory locations in intermediate address space 204 by RATU 206. The particular mapping between intermediate address space 204 and real address space 208 can be defined or modified by system software (e.g., an operating system, hypervisor, or other firmware). For example, system software may direct RATU 206 to map every “Nth” memory location in real memory starting at real memory address “A” to a corresponding address in a contiguous block of addresses in the intermediate address space starting at intermediate address “B.” This ability makes it possible to effectively “re-arrange” the contents of main memory without performing any actual manipulation of the physical data. This facility is useful for processing data that is stored in the form of a matrix or data that is stored in an interleaved format (e.g., video/graphics data).

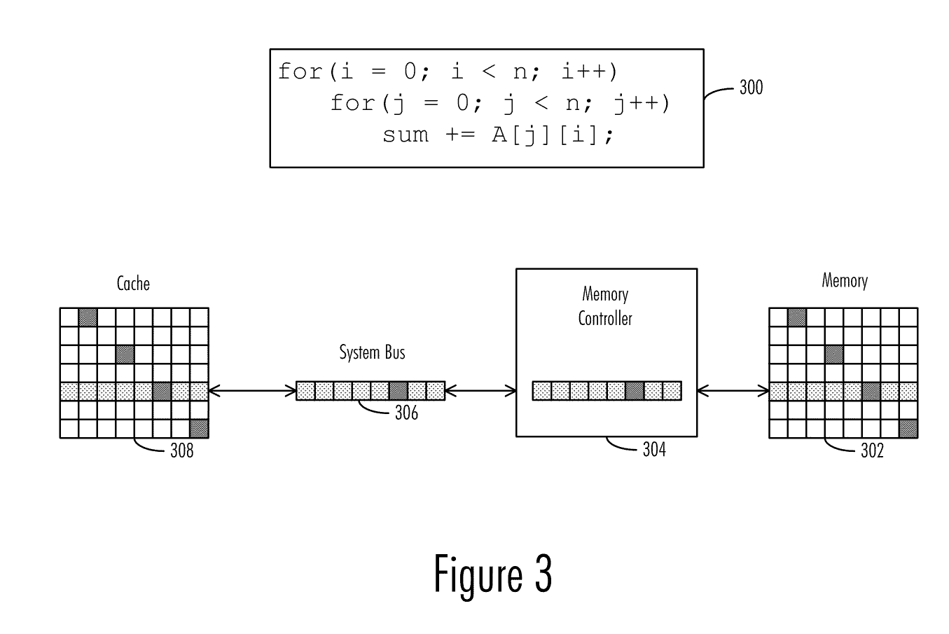

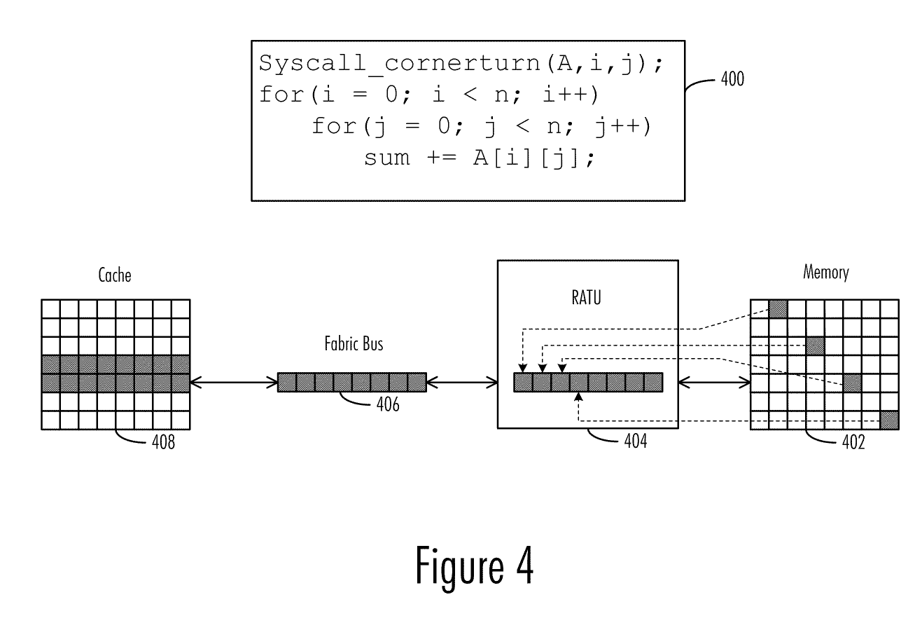

An example of an application in which a preferred embodiment of the present invention is well suited is provided in FIGS. 3 and 4. In FIG. 3 it is assumed that intermediate addresses have not been used to remap main memory—that is to say, FIG. 3 illustrates a problem that may be solved through the judicious use of intermediate addresses in accordance with a preferred embodiment of the present invention (as in FIG. 4). Turning to FIG. 3, a fragment 300 of program code in a C-like programming language is shown, in which a two-dimensional array (or “matrix”) of data is accessed in column-major order (the reader familiar with the C programming language will appreciate that arrays in C are stored in row-major order, as opposed to the column-major order employed by languages such as Fortran).

Because the array is stored in memory in row-major order in real memory 302, the sequence of successive memory accesses performed by the doubly-nested loop in code fragment 300 will be at non-contiguous locations in main memory 302. In this example, it is presumed that the rows in the matrix are of a size that is on the order of the size of the cache lines employed in cache 308. Thus, in this example, each successive memory access requires a different cache line to first be retrieved from main memory 302 by memory controller 304, transmitted over system bus 306 and placed into cache 308 before processing on that memory location may proceed. This is inefficient because each retrieval of a cache line from main memory takes time and uses space within cache 308.

FIG. 4 illustrates how intermediate addresses may be used to improve cache efficiency in the scenario described in FIG. 3. Code fragment 400 is similar to code fragment 300 (indeed, it performs the same function), but code fragment 400 is different in that before the loop, a system call is made to re-map the matrix in the intermediate address space so that the matrix appears transposed (i.e., rows are swapped for columns) in the intermediate address space. Note that this system call does not involve the movement of data in physical memory 402; it only redefines the mapping performed by RATU 404. Once this system call is complete, the loop in code fragment 400 traverses the matrix, but does so in row-major order. Because of the system call, however, this row-major traversal, with respect to physical memory 402, is actually a column-major order traversal (as the rows and columns of the matrix appear reversed in the intermediate address space). Hence, code fragment 400 is semantically equivalent to code fragment 300.

However, execution of code fragment 400 is much more efficient, as fewer cache lines need be retrieved. Because RATU 404 maps the non-contiguous data items in a single column of the matrix in real memory into a contiguous block of the transposed matrix in the intermediate address space, RATU 404 arranges non-contiguous data items from real memory 402 into a contiguous cache line. Because RATU 404 makes the data items appear contiguous in the intermediate address space, fewer cache lines need be transmitted over system bus 406 and entered into cache 408, since each cache line retrieved contains only those data items that will be used right away. This results in not only a performance increase (due to fewer cache misses), but also a savings in resources, since fewer cache lines need be loaded into cache 408.

While particular embodiments of the present invention have been shown and described, it will be obvious to those skilled in the art that, based upon the teachings herein, changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an;” the same holds true for the use in the claims of definite articles. Where the word “or” is used in the claims, it is used in an inclusive sense (i.e., “A and/or B,” as opposed to “either A or B”).

What is claimed is:

1. A method for execution in a computer, comprising:
assembling, within the computer, data from a plurality of non-contiguous addresses in a real address space into a cache line within a cache, wherein the cache line represents a contiguous block of addresses in an intermediate address space;
translating, in an address translation unit of the computer, an effective address in a virtual address space into an intermediate address in the intermediate address space, wherein the intermediate address space falls within the contiguous block of addresses represented by the cache line; and
performing a memory access operation on the cache line at a location specified by the intermediate address.

2. The method of claim 1, further comprising:
writing data contents of the cache line to the plurality of non-contiguous addresses in the real address space.

3. The method of claim 1, wherein the plurality of non-contiguous addresses within the real address space are equally spaced within the real address space.

4. The method of claim 1, wherein the plurality of non-contiguous addresses represent values along a single dimension of a matrix.

5. The method of claim 4, wherein the contiguous block of addresses in the intermediate address space represents a portion of a transpose of the matrix.

6. The method of claim 1, wherein the data access is a read operation.

7. The method of claim 1, wherein the data access is a write operation.

8. A computer program product in a computer-readable storage medium of executable code, wherein the executable code, when executed by a computer, directs the computer to perform actions of:
assembling, within the computer, data from a plurality of non-contiguous addresses in a real address space into a cache line within a cache, wherein the cache line represents a contiguous block of addresses in an intermediate address space;
translating, in an address translation unit of the computer, an effective address in a virtual address space into an intermediate address in the intermediate address space, wherein the intermediate address space falls within the contiguous block of addresses represented by the cache line; and
performing a memory access operation on the cache line at a location specified by the intermediate address.

9. The computer program product of claim 8, further comprising:
writing data contents of the cache line to the plurality of non-contiguous addresses in the real address space.

10. The computer program product of claim 8, wherein the plurality of non-contiguous addresses within the real address space are equally spaced within the real address space.

11. The computer program product of claim 8, wherein the plurality of non-contiguous addresses represent values along a single dimension of a matrix.

12. The computer program product of claim 11, wherein the contiguous block of addresses in the intermediate address space represents a portion of a transpose of the matrix.

13. The computer program product of claim 8, wherein the data access is a read operation.

14. The computer program product of claim 8, wherein the data access is a write operation.

15. A data processing system comprising:
a main memory;
a processing unit;
a memory cache accessible to the processing unit;
a first address translation unit, responsive to the processing unit's attempts to access memory addresses, which translates a processing-unit-specified effective address in a virtual address space into an intermediate address in an intermediate address space; and
a second address translation unit, wherein the second address translation unit assembles, within the computer, data from a plurality of non-contiguous addresses in the main memory into a cache line within the memory cache for use by the processing unit, wherein the cache line represents a contiguous block of addresses in an intermediate address space.

16. The data processing system of claim 15, wherein the data in the cache line is copied to said plurality of non-contiguous addresses in the main memory following an update of the data contained in the cache line.

17. The data processing system of claim 16, wherein the data is copied to said plurality of non-contiguous addresses in the main memory immediately following an update of the data contained in the cache line.

18. The data processing system of claim 15, wherein the plurality of non-contiguous addresses within the main memory are equally spaced within the main memory.

19. The data processing system of claim 15, wherein the cache line is addressed within the memory cache by tag bits and the tag bits correspond to a location within the intermediate address space.

20. The data processing system of claim 15, further comprising:
one or more additional processing units, wherein each the one or more additional processing units share use of the main memory.
